(19) United States
(12) Patent Application Publication
(10) Pub. No.: US 2007/0172540 A1
(43) Pub. Date: Jul. 26, 2007

(54) HIGH DENSITY, ENERGY COMPONENT-ADDED PELLETIZED AGRICULTURAL PROCESSING BYPRODUCTS FOR ANIMAL FEED

(76) Inventors: Charles E. Neece, Redwood Falls, MN (US); Larry Risty, Redwood Falls, MN (US)

Correspondence Address: Thomas W. Adams;RENNER, OTTO, BOISSELLE & SKLAR, LLP, 19th Floor, 1621 Euclid Avenue, Cleveland, OH, 44115, US

(21) Appl. No.: 11/625,943

(22) Filed: Jan. 23, 2007

Related U.S. Application Data
(60) Provisional application No. 60/761,865, filed on Jan. 25, 2006.

(51) Int. Cl. A23K 1/18

(52) U.S. Cl. 426/2

(57) ABSTRACT

An animal feed in pellet form including one or more agricultural raw material byproduct and a glycerin binder. The animal feed may also include nutritional additives, vitamins, minerals, antibiotics, hormones and sweeteners in effective amounts. Further provided is a process for preparing an animal feed product, including providing one or more agricultural raw material byproduct; blending the one or more agricultural raw material byproduct with a quantity of glycerin; and pelletizing the blended agricultural raw material byproduct and glycerin into pellets. The glycerin may be present at a concentration effective to bind the blended one or more agricultural raw material byproduct and glycerin into a stable pellet, and may also be present at a concentration effective to improve the shelf life of the one or more byproduct.

### CROSS-REFERENCE TO RELATED APPLICATION

The present application is based upon and claims benefit of U.S. Provisional Application No. 60/761,865, filed 25 Jan. 2006, the entirety of which is incorporated herein by reference.

### FIELD OF THE INVENTION

The present invention relates to an animal feed product including byproducts from agricultural raw material processing and glycerin, in which the product may be formed into a pellet, with glycerin as the binder for the pellet.

### BACKGROUND OF THE INVENTION

Various byproducts from agricultural raw material processing, e.g., for human food and beverage production, are available and have been used as an animal feed supplement product. Such agricultural raw material byproducts typically have a wide range of crude protein content, typically in the range of 5% to 87%, and include energy contents ranging from 0.65-1.0 Mcal/lb (see, for example, Amaral-Phillips, D. M. and Hemken, R. W., “Using Byproducts to Feed Dairy Cattle,” Cooperative Extension Service, University of Kentucky College of Agriculture (1997). Such agricultural raw material byproducts include, for example, oilseed byproducts, gluten and hominy byproducts, brewer's and distiller's byproducts, wheat millfeed byproducts, dairy byproducts, oats and rice byproducts, dried pulp and grain byproducts. This is a representative listing and grouping of exemplary agricultural raw material byproducts and is not intended to be limiting. Such agricultural raw material byproducts are widely available commercially.

The use of such agricultural raw material byproducts as animal feed also has some associated problems. The byproducts have widely variable protein, fat and moisture contents, even for the same type of materials. For example, dried distiller's grains plus solubles may have a protein content ranging from 20 to 33% of the dry matter, and a fat content ranging from 6 to 20% of the dry matter. Because the dry distiller's grain plus solubles starts as a thin slop, it must be dried. The drying process may be stopped well before all the water is removed, resulting in a product having a water content ranging from 0 to 40%. Another problem is that the energy content of the byproducts varies over a wide range.

Finally, the quality of animal feed pellets is a continuing problem, in that pellets without sufficient durability are prone to excessive breakage and fines production during transport and handling, thereby increasing losses when the pelletized animal feed is lost due to such breakage and fines production. Fines can cause respiratory problems resulting from inhalation by the animals during feeding. A continuing need exists for pellets having good durability. This problem exists particularly with materials such as many of the above-noted agricultural raw material byproducts, which generally may include finely divided powdery portions. In addition, the durability of pellets may be adversely effected when feed additives are included.

Thus, producing a agricultural raw material byproduct-based animal feed product in pellet form with a density at the desired level, in a compact, durable, easily transportable form would be highly beneficial. A further benefit would be the ability to add selected necessary and/or desirable nutrients, vitamins, minerals, antibiotics, hormones and/or sweeteners to such a product as needed without requiring extensive reformulation, while still obtaining the desired pellet features.

Therefore, a continuing need exists for a high quality agricultural raw material byproduct material which can be provided for use as an animal feed in pellet form, in which the pellets are durable, nutritious, and which can have desired additives included as needed.

### SUMMARY OF THE INVENTION

The present invention addresses the foregoing problems and responds to the continuing need for such a pelletized agricultural raw material byproduct useful for animal feed. In accordance with one embodiment of the invention, one or more agricultural raw material byproducts is blended with a appropriate quantity of glycerin and, if desired, other ingredients such as nutrients, vitamins, minerals, antibiotics, hormones and sweeteners in selected proportions, and pelletized to form a high density pelletized product with an increased energy content, which is useful, for example, as an animal feed product.

Thus, in one embodiment, the present invention relates to an animal feed in pellet form comprising an agricultural raw material byproduct and a glycerin binder. In other embodiments, additional materials such as one or more of nutritional additives, vitamins, minerals, antibiotics, hormones and sweeteners, may be added to the mixture used in the pellets. In one embodiment, the animal feed includes a combination of the byproducts and/or nutritional additives selected to provide a nutritionally effective amount of protein, fat, carbohydrate and/or nutritional additive.

In another embodiment, the present invention relates to a process for preparing an animal feed product, comprising providing one or more agricultural raw material byproduct; blending the one or more byproduct with a quantity of glycerin sufficient to bind the blended one or more byproduct and glycerin into a stable pellet; and pelletizing the blended one or more byproduct and glycerin into pellets. In other embodiments, additional materials, such as one or more of nutritional additives, vitamins, minerals, antibiotics, hormones and sweeteners, may be added in the blending step, prior to pelletizing. In one embodiment, the process includes selecting a combination of the byproducts and/or nutritional additives to provide a nutritionally effective amount of protein, fat, carbohydrate and/or nutritional additive.

In one embodiment, the present invention relates to formulations for, e.g., animal feed products, comprising one or more agricultural raw material byproduct and glycerin. The formulations may be provided in the form of a pellet. In some embodiments, additional nutrients, vitamins, minerals, and other additives may be incorporated in the formulations to further improve the feed quality of the products. These formulations may be used as animal feed supplements. These formulations may be prepared by mixing the byproducts with glycerin and, if desired, the other additives, and pelletizing the mixture. The resulting product not only has a higher density, but the glycerin adds an energy component to the formulation, increasing the energy content of the pelletized byproducts. In one embodiment, the energy content is increased to about 1,300 Kcal/lb. or more.

There are further economic and practical benefits to the invention, if the components other than the agricultural raw material byproducts are selected on the basis of the lowest cost and/or prevention of disposal costs of same. For example, industrial grade glycerin, including glycerin produced as a by-product of processes of converting vegetable oils or rendered fats to produce biodiesel, is available at a low cost and is thus an economic aid to pelletizing byproducts for animal feed. As a further example, if the nutrients to be added include certain phosphorus and sulfur compounds, they may be obtained from a degumming operation to remove phospholipids, phosphoric acid and other water-soluble phosphorus compounds and water-soluble sulfur compounds from crude vegetable oils or rendered fats. The wash water from the degumming steps containing such phosphorus and sulfur compounds are costly to dispose of as a waste stream and thus it is cost-effective if this wash water or a concentrate obtained from it could be added to the pelletized product of the invention. Of course, the phosphorus and sulfur compounds for use with the invention may also be obtained from other sources. In addition, other nutrients, vitamins, minerals, etc., may be added as needed for any particular application.

An additional benefit of the present invention, and a solution to the problem of variable content of the agricultural raw material processing byproducts, is the ability to select and combine the byproducts and/or nutritional additives to provide a nutritionally effective amount of protein, fat, carbohydrate and/or nutritional additive. Thus, by selectively combining various of the byproducts and/or combining such byproducts with one or more nutritional additives, a consistent animal feed can be prepared, having virtually any desired combination of protein, fat, carbohydrate and/or nutritional additive as needed for any particular application.

### BRIEF DESCRIPTION OF THE DRAWINGS

FIG. 1 is a block diagram schematically illustrating the steps in one embodiment of a process in accordance with the present invention for producing pelletized formulations comprising agricultural raw material byproducts, glycerin and, if desired, other ingredients.

FIG. 2 is a schematic diagram schematically illustrating a plant for carrying out an embodiment of the present invention, for producing pelletized formulations comprising agricultural raw material byproducts, glycerin and, if desired, other ingredients.

FIGS. 3 and 4 are schematic diagrams illustrating additional embodiments of processes for producing pelletized formulations comprising agricultural raw material byproducts, glycerin and, if desired, other ingredients.

### DETAILED DESCRIPTION OF THE INVENTION

Agricultural raw material byproducts, within the scope of the present invention, include one or more or a mixture of any material within any of the following groups:

Oilseed Byproducts. These byproducts are the materials left after the vegetable oil content has been extracted from the oilseeds. These byproducts include: soybean meals (high and low protein grade), soybean hulls, whole cottonseed, cottonseed meal, cottonseed hulls, canola meal, sunflower seed meal, linseed meal, corn meal, rapeseed meal and safflower meal. Other materials from which oils are commonly extracted may also be included in this group, e.g., other Brassica species. Depending upon the oilseed and on the extraction process used, residual oil may be in the range of 2 to 12% by weight.

Gluten and Hominy Feed: These are byproducts from corn processing. Corn gluten is a by-product of wet milling process to make cornstarch. Corn germ meal is golden-yellow and is mainly gluten, the high-protein portion of the corn kernel. Corn gluten meal may contain about 20% protein, about 2% fat and about 9% fiber. Corn gluten feed is an intermediate protein product that is rich in highly digestible fiber, and may contain about 21% protein, about 2.5% fat and about 8% fiber, but the crude protein values have ranged from 17 to 26% and the fat content may range from 1 to 7%. Wet corn gluten feed is similar but is not dried.

Brewers and Distillers: Brewers and distillers' dried grains are grain-based byproducts from the production of alcohol for a variety of uses, including alcohol-containing drinks such as beer and whiskey, petroleum additive and for other uses. Distillers grains contain the nutrients remaining after the corn starch is fermented into alcohol. The distillers grains can be sold wet or dried. Wet distillers grains are higher in protein and energy than corn gluten feed because gluten and oil remain in distillers grains. When distillers grains are dried they lose some energy value compared to wet products. Dried distillers grains and dried distillers grains with solubles are marketed widely around the world as a feed commodity.

Dried brewers grains is the dried extract residue of barley malt alone or in mixture with other cereal grains from the manufacture of wort or beer.

Distillers dried grains (DDG) are obtained after the removal of ethyl alcohol by distillation from the yeast fermentation of a grain or a grain mixture by separating the resultant coarse grain faction of the whole stillage and drying it by various methods.

Distillers dried grains/solubles (DDGS) are recovered in the distillery and contain substantially all of the nutrients from the incoming corn except for the starch, which has been fermented into alcohol. It has been estimated that DDGS has at least threefold the nutrients as the incoming grain. DDGS has been estimated to contain about 27% protein, about 11% fat and about 9% fiber.

Condensed distillers solubles (CDS) is a term generally used to refer to the evaporated co-products of the grain fermentation industry. On a dry matter basis CDS typically is about 29% protein, about 9% fat and about 4% fiber. The solubles are an excellent source of vitamins and minerals, including phosphorus and potassium. CDS can be dried to 5% moisture and marketed, but generally the dry matter content is between 25-50%.

Wet distillers grains (WDG) can be used as livestock feed or dried into distillers grains (DDG). If syrup is added to wet distillers grains and dried, the resulting product is referred to as distillers dried gains with solubles (DDGS).

Wheat Millfeed Byproducts: Byproducts such as shorts, millrun, bran and middlings are produced when wheat is processed to obtain certain food qualities. These byproducts are not desired for human consumption and so can be fed to animals. These byproducts of milling wheat for flour include varying amounts of bran, germ and flour. They are highly palatable, low in calcium and tend to be higher in phosphorus than most other grains and processed grain by-products. Wheat bran is highest in fiber and phosphorus and lowest in energy. Wheat middlings (also called midds) is a common ingredient in cattle feeds. Midds are a by-product of the flour milling industry comprising several grades of granular particles containing different proportions of endosperm, bran and germ. Midds have about 96 percent of the energy value of barley and about 91 percent of the energy value of corn. Midds are palatable feedstuffs and can be included in a grain mixture at high levels.

Dairy Byproducts: When milk is treated to form certain products such as dried skim milk, dried buttermilk, whole whey or whey protein concentrate a common significant step would be the removal of the butterfat.

Oats, Rice Byproducts: These products from oats or rice processing include rolled-oats, crimped oats, pulverized oats, reground oat feed, oats or rice mill feeds and rice hulls, rice screenings, rice fines and rice gluten.

Grain Byproducts: Byproducts such as barley feed, feed wheat, corn, milo and ground grain screenings. Byproducts of these materials may be used or, as needed to supplement the other byproducts, these grain materials may be used as primary feed materials, rather than as byproducts, in combination with the agricultural raw material byproducts described herein.

Additional agricultural raw material byproducts may include hydrolyzed feather meal, liquid whey, meat meal, meat and bone meal, molasses, peanut skins, tallow, yellow grease and fish meal, as well as other byproducts and other additives that are known for use in animal feeds.

The agricultural raw material byproduct materials useful in the present invention include all of those described above. These byproduct materials are generally known in the art and are commercially available. The price and availability of such materials may vary significantly by geographical location, season, weather conditions, etc., as is known. Since these byproducts are well know to those of ordinary skill in the art and are generally widely available, a more extensive discussion of such byproducts is not set forth here.

In accordance with the present invention, one or more of these agricultural raw material byproduct materials are blended with a quantity of glycerin sufficient to bind the materials together when the mixture is formed into pellets.

In accordance with the present invention, glycerin is used as a binder in forming pellets of one or more of the agricultural raw material byproduct materials. As used herein, “glycerin” refers to 1,2,3-trihydroxypropane, also known as glycerol. The more common name, glycerin, is used herein. The glycerin used should be of sufficient purity to be acceptable for use in an animal feed. The glycerin may be provided in any suitable grade, again provided that it is acceptable for use in animal feed. The glycerin may be pre-sterilized, pasteurized, purified or otherwise treated to assure its acceptability in this regard. The glycerin may be, for example, industrial grade, technical grade, reagent grade or USP/NF grade. The industrial grade may be, for example, a by-product of fat or oil hydrolysis and/or transesterification, and in some cases may contain 10-15% water.

In one embodiment, the amount of glycerin added to the agricultural raw material byproduct materials is in the range from about 2 wt % to about 25 wt % on a moisture-free basis. In another embodiment, the amount of glycerin added to the agricultural raw material byproduct materials is in the range from about 5 wt % to about 15 wt % on a moisture-free basis. In another embodiment, the amount of glycerin added to the agricultural raw material byproduct materials is in the range from about 8 wt % to about 12 wt % on a moisture-free basis. Here, as elsewhere throughout the specification and claims, the numerical limits of the disclosed ranges and ratios may be combined. Thus, for example, the foregoing disclosure is understood to include ranges from about 5 wt % to about 12 wt % and from about 2 wt % to about 8 wt % on a moisture-free basis, even though such ranges were not explicitly recited.

Expressed as a ratio, in one embodiment, the animal feed pellets comprise an average weight ratio of the agricultural raw material byproduct materials to glycerin in the range from about 50:1 to about 3:1. In another embodiment, the animal feed pellets comprise an average weight ratio of the agricultural raw material byproduct materials to glycerin in the range from about 10:1 to about 4:1.

In one embodiment, the glycerin is present at a concentration sufficient to bind the one or more byproduct and glycerin together into a durable pellet.

The use of glycerin as a binder in the pellets of the present invention provides a number of benefits. It is known that glycerin may act as a humectant when added to foodstuffs and feeds, and it does so in the present invention as well. In addition, the glycerin may also act as a sweetener. In the present invention, the glycerin goes further, acting as a binder, and n one embodiment, it is not added as a plasticizer, but instead acts to bind the ingredients together into a more solid, durable whole. In one embodiment, the glycerin contributes to the hardness and/or durability of the pellets.

In one embodiment, the animal feed in pellet form in accordance with the present invention is for use in ruminant animals. Ruminant animals include, for example, cattle, sheep and goats. In one embodiment, the animal feed in pellet form in accordance with the present invention provides improved rumen bypass when fed to ruminant animals. As is known in the animal feed arts, rumen bypass is important in ruminant animals, such as dairy cows. Dairy cows obtain their protein needs both from synthesis by the microbes living in the rumen (the first compartment of the cow's stomach) and from dietary protein that escapes digestion by these same organisms. Rumen microbes often reduce the protein value of feeds by degrading more protein than they resynthesize. As a result, even high quality feeds may be used inefficiently for milk production, and/or for other needs of ruminant animals. The amount of protein escaping the rumen, referred to by dairy farmers and those of ordinary skill in the dairy feed science as ‘bypass protein’, determines much of the value of feeds. In one embodiment, the animal feed in pellet form of the present invention provides improved bypass protein when compared to an animal feed containing substantially the same ingredients but not made in accordance with the present invention, that is, not in pellet form with glycerin as the binder. In one embodiment, the animal feed in pellet form of the present invention provides improved rumen bypass not only of protein but of other carbohydrates, fats, nutrients, vitamins and other additives included in the animal feed of the invention, when compared to an animal feed containing substantially the same ingredients but not made in accordance with the present invention, that is, not in pellet form with glycerin as the binder. The improved rumen bypass characteristics of the animal feed in pellet form of the present invention means that there will be an increased contribution to the overall nutrition of the ruminant animal when the animal is fed this feed product.

As noted above, glycerin acts as a humectant in the pellets of the present invention, as well as acting as the binder. It has been discovered that use of the glycerin as the binder, that is, in amounts sufficient to bind together the raw material byproducts used in the present invention, provides an additional benefit in that it contributes to the stability of ingredients in the animal feed mixture. One specific group of ingredients that are stabilized by the glycerin are the fats, oils fatty acids and fatty acid esters and salts that are present as components of the animal feed. It has been discovered that the glycerin in the invention helps to prevent oxidation of unsaturated fatty acids present in these materials, whether the fatty acids present are in free form, are esterified to glycerin or other alcohols, or are salts. In one embodiment, glycerin is present in the animal feed pellets at a concentration effective to improve shelf life of the one or more byproduct. The range of concentration providing this benefit is within the range of concentration of glycerin disclosed herein. Thus, the animal feed in pellet form in accordance with at least one embodiment of the present invention has improved shelf-life as compared to a similar feed material not using glycerin as described herein. This feature of the present invention results in an improvement both in nutrition and in consumption, since animals tend to consume less of a feed having a rancid taste or character. Any rancidity present also reduces the nutritional impact of the fatty acids even of the product that is consumed in spite of the taste. The antioxidant effect of the glycerin in the animal feed in pellet form of the present invention is a new, not previously known feature of the present invention. Another benefit obtained from the use of glycerin is that it is relatively inexpensive and is readily and widely available commercially.

In one embodiment, the animal feed includes a combination of the byproducts and/or nutritional additives selected to provide a nutritionally effective amount of protein, fat, carbohydrate and/or nutritional additive. Similarly, in one embodiment of the process there is included a step of selecting a combination of the byproducts and/or nutritional additives to provide a nutritionally effective amount of protein, fat, carbohydrate and/or nutritional additive. In this way, one of the problems in the prior art can be addressed, specifically, the problem of variability in agricultural raw material processing byproducts, in nutritional content. Such variability can be overcome by selecting and combining the byproducts and/or combining one or more selected byproducts with appropriate nutritional supplements or additives. In one embodiment, the nutritional additives are introduced in the form of wash water from a de-gumming process for crude vegetable oils or rendered fats or a concentrate thereof.

As used herein, a “nutritionally effective amount” is that amount which will provide the protein, fat, carbohydrate, vitamin, supplement, caloric or energy value desired for the particular product. For example, the nutritionally effective amount of a proteinaceous additive to be added to a particular animal feed can be easily determined by those of ordinary skill in the art given the amino acid content or deficiency of the initial byproduct and of the proteinaceous additive and its amino acid availability. A nutritionally effective amount of the proteinaceous material in one embodiment is a quantity that will increase the protein content of the animal feed to the 8% to 10% level ordinarily found in cereal grain based ruminant rations. Where a particular deficiency in an animal is to be addressed, the nutritionally effective amount of protein can exceed 20% by weight of total feed. Nutritionally effective amounts of the various byproducts, additives, supplements, minerals, vitamins and other ingredients disclosed herein can be determined by those of ordinary skill in the art. The present invention enables such person to adjust the relative amounts of selected byproducts, additives, supplements, vitamins, minerals and other ingredients disclosed herein to obtain a nutritionally effective amount of each, and thereby to provide an optimally balanced diet to the livestock of interest.

The use of glycerin as a binding agent for pellet formation, as disclosed herein, provides the flexibility needed to enable the selection of nutritionally effective amounts of ingredients without undue concern to compatibility of the ingredients. That is, one can select the ingredients based on nutritional needs of the animals and byproduct nutritional availability, and can make adjustments as needed quickly and easily.

In one embodiment, the agricultural raw material byproduct materials is processed in about 200-220 lb (about 90-100 Kg) batches. Glycerin is added to the agricultural raw material byproduct materials with appropriate mixing. For example, if a 10% content of glycerin on a moisture-free basis is desired, about 20 lb (about 9.1 Kg) of glycerin is used in a 200 lb batch, assuming the agricultural raw material byproduct materials and the glycerin have approximately the same moisture content. If there is a substantial difference in the moisture contents of the agricultural raw material byproduct materials and the glycerin, appropriate adjustments should be made to obtain the desired ratio. Some testing may be needed in order to optimize the ratio of the agricultural raw material byproduct materials from a particular source to glycerin from a particular source to obtain the desired stable pellets.

In other embodiments, the agricultural raw material byproduct materials may be processed with the glycerin to form the pellets on a continuous basis, with the agricultural raw material byproduct materials being directly mixed with glycerin and any other ingredients, and the mixture fed directly into a pelletizing apparatus from which finished pellets are produced. Such a continuous process is within the skill in the art.

In one embodiment, the agricultural raw material byproduct materials and glycerin, together with desired additives such as described herein, are blended batch-wise in a horizontal ribbon mixer with a capacity of 300 lb/hr (about 136 kg/hr). A suitable mixer, fabricated by Scott Equipment Company, New Prague, Minn., has dimensions of 24″ by 36″ by 28″ deep (about 61 cm×91 cm×71 cm deep), and is powered by a 6 HP motor.

In one embodiment, after the blending step, the blended mixture is conducted to a pellet mill or pelletizer for production of pellets. A suitable pelletizer is a California Pellet Mill, “Master” Model, powered by a 40 HP motor. Compression ratios ranging from about 5:1 to about 15:1 may be used, and in one embodiment, a compression ratio from about 8:1 to about 11.5:1 may be used. The die opening is selected to provide a pre-determined pellet size, such as for example, from about ⅛″ (about 3.2 mm) to about ½″ (about 12.7 mm) and in one embodiment, a die opening of about 5/32″ (about 4 mm) may be used.

As noted, in some embodiments additives may be included with the agricultural raw material byproduct materials and glycerin. Such additives may be suitably selected to provide a nutritionally effective amount of each such additive. In one embodiment, one or more of nutritional additives (e.g., proteins, nitrogen sources, fats, fatty acids, fibers) vitamins, minerals, antibiotics, hormones, sweeteners and stabilizers may be added to the agricultural raw material byproduct materials and glycerin in preparing the animal feed of the present invention. In one embodiment, the nutritional additives comprise one or more of phospholipids, water-soluble phosphorus compounds and water-soluble sulfur compounds. Non-limiting examples of nutritional additives include protein, amino acids, fats, fibrous materials, growth promoters and enzymes. For example, enzymes to improve the efficiency of raw material digestion may be added, such as enzymes to assist in conversion of non-starch carbohydrates into a useable form. Non-limiting examples of enzymes include endo-1,4-beta xylanase, endo-1,4-beta glucanase, alpha-galactosidase, alpha-amylase and 3-phytase. An example of a growth promoter is potassium diformate. Non-limiting examples of vitamins include vitamin A, the B vitamins, vitamin C, vitamins D₂ and D₃, vitamin E, vitamin K, biotin, choline, folic acid, pantothenic acid and any other vitamins needed. Non-limiting examples of minerals include, for example, iron, copper, zinc, manganese, cobalt, iodine and selenium, as well as calcium and salt, and may also include elements such as molybdenum, nickel, fluorine, vanadium, tin and silicon. Non-limiting examples of antibiotics include flavophospholipol, salinomycin sodium, avilamycin, robenidine HCI, lasalocid A sodium, halofuginone HBr, maduramicin ammonium alpha, narasin and diclazuril. Additional growth-promoting antibiotics include, for example, bacitracins, bambermycins, chlortetracycline, lincomycin penicillin, tylosin and virginiamycin. A non-limiting example of a hormone includes melengestrol acetate (an estrus suppressor). Non-limiting examples of sweeteners include feed grade molasses, sugar and sodium saccharin. It is noted that a supplemental sweetener may not be needed, since glycerin has a substantial sweetness of its own. Other known additives for animal feeds may be added as well, such as microorganisms (e.g., yeasts), ionophores, anthelmintics and anticoccidials. Non-limiting examples of stabilizers include agar-agar, alginates such as calcium, sodium or potassium alginate, gums such as gum arabic, gum ghatti, guar gum, locust bean gum and gum tragacanth. Non-limiting examples of fatty acids include mono-, di- and tri-glyceride esters of fatty acids, free fatty acids, soap stock from vegetable oil refining, methyl and/or ethyl or higher alcohol esters of fatty acids, fatty acid salts. Non-limiting examples of fats include the aforementioned tallow, and lard, butterfat, Neat's foot oil, cod-liver oil and vegetable oils. Non-limiting examples of fibrous materials include the aforementioned oilseed hulls, dried apple pectin and pomace, almond hulls, bagasse, dried bakery product, buckwheat hulls, ground or cut grass, straw or alfalfa, beet fiber, psyllium CFS and hydrolyzed roughage. The foregoing list is exemplary and is not intended to be limiting. Any other known additives for animal feed can be added to the composition of the present invention. Particular additives may be selected and used in a nutritionally effective amount based on the type of animal to which the pellets of the present invention are to be fed, and based on the various nutritional contents of the byproduct(s) that is/are being used in the animal feed.

In one embodiment, the pelletized agricultural raw material byproduct may be prepared as a total mixed ration. A total mixed ration (TMR) is composed of a combination of forages, byproducts (such as those described herein), and any additional grains, protein supplement(s), minerals, and vitamins that may be needed. The TMR is mixed together to make a balanced ration in which the weight of each ingredient can be selected and controlled. As is known, such a TMR may then be offered to cattle or other livestock as their sole source of feed. By blending together all the various materials and pelletizing with glycerin, the animals are less able to selectively consume individual ingredients. By using pelletizing as described herein, the TMR can always contain the same proportion of ingredients as selected, or can be adjusted as needed to provide the desired nutritionally effective amounts.

In one embodiment, the bulk density of the pelletized animal feed, when formed into pellets, may range from about 25 lb/ft³ to about 45 lb/ft³ (about 400 kg/m³ to about 720 kg/m³). In another embodiment, the bulk density may range from about 30 lb/ft³ to about 40 lb/ft³ (about 480 kg/m³ to about 640 kg/m³), and in one embodiment, the bulk density is about 34 lb/ft³ to about 36 lb/ft³ (about 545 kg/m³ to about 577 kg/m³), or about 35 lb/ft³ (about 561 kg/m³).

The bulk density of the pelletized animal feed may be determined by weighing a calibrated container of a given volume in cubic feet filled with the pellets. After subtracting the tare, the correct weight was divided by the volume to yield pellet bulk density in, e.g., lb/ft³ or kg/m³.

While a greater density is desirable for better pellet durability, there are limitations as to how dense the pellet can be. Too high a density of the pellets, may prevent proper crumbling when ingested by the animal and/or prevent good mixing with other feed components limiting their use as a feed additive. That is, if the pellets are too dense, they can be hard to digest, resulting in pass-through, and/or they can settle out of the feed or become non-uniformly dispersed and thereby either not be available at all or not be uniformly provided to all animals in a herd or group. If the density is too low, the pellets may be crumbly, breaking apart too easily and allowing the mixture to become finely divided and/or powdery, which could result in reduced usefulness. Thus, for most purposes, the pellets should be within the above-disclosed bulk density ranges.

After drying and cooling of the pellets discharged from the pellet mill, the pellets may be tested for durability using, in one embodiment, a two compartment pellet durability tester supplied by Continental-Agra Equipment, Inc., Newton, Kans. Another suitable pellet durability tester is available from Seedburo Equipment Co., Chicago, Ill. The pellet durability tester utilizes a standard test developed by Kansas State University to predict the amount of fines produced by handling pellets before, e.g., feeding to animals. This test has been shown to have reliable and reproducible results. The durability test is carried out using a specially designed pellet tumbler which reliably duplicates (or approximates) the amount of breakage that normally occurs from the time the pellets are expelled from the pelletizer until they are consumed by an animal. The results of the tests are interpreted as a standard measure of quality which is referred to as the Pellet Durability Index (P.D.I.). The test is simple to perform and requires a minimal amount of equipment. The procedure:

1. Secure a representative sample.

2. Remove broken pellets from the sample with appropriate hand sieve.

3. Weigh out 500 grams of screened sample.

4. Tumble 500 grams of screened pellets for 10 minutes.

5. Re-screen and weigh the whole pellets remaining from the 500 gram sample.

6. Compute Pellet Durability Index by dividing the weight of the whole pellets in grams by 500 grams and multiplying by 100. Thus, the durability is expressed in percent.

The foregoing procedure is similar to that described in Feed Manufacturing Technology III (American Feed Industry Association, Arlington Va. McEllhiney, R. R. (technical Editor), 1985, Appendix G, Wafers, Pellets, and Crumbles—Definitions and methods for determining specific weight, durability, and moisture content; Section 6 Durability; Paragraph 2, Pellets and crumbles). Feed pellets desirably have a PDI of at least about 90%. A pellet will lose its ability to stay together as the PDI falls.

In one embodiment, the pellet durability is in the range from about 90% to about 99%, when durability is determined according to the foregoing method. In another embodiment, the pellet durability is in the range from about 95% to about 98%, when durability is determined according to the foregoing method.

Pellet durability is important for avoiding crumbling, breakage and/or moisture absorption by the pellets. Pellet durability is also important for providing the improved rumen bypass discussed herein. Since the pellet is more durable, it is less subject to both damage by physical contact and by chemical attack, such as by the conditions in the rumen of a ruminant animal.

In one embodiment, the energy content of the animal feed is in the range from about 1,260 Kcal/lb to about 1,500 Kcal/lb. on a dry weight basis. In another embodiment, the energy content of the animal feed is in the range from about 1,300 Kcal/lb to about 1,400 Kcal/lb. on a dry weight basis, and in another from about 1,300 Kcal/lb to about 1,350 Kcal/lb.

By providing the animal feed in pellet form in accordance with the present invention, the animal feed has improved flowability and therefore enhanced handling, storage and ease of unloading and transferring. Since the pellets are relatively hard and quite durable, there is less dust formation, less fines formation, and thereby reduced loss.

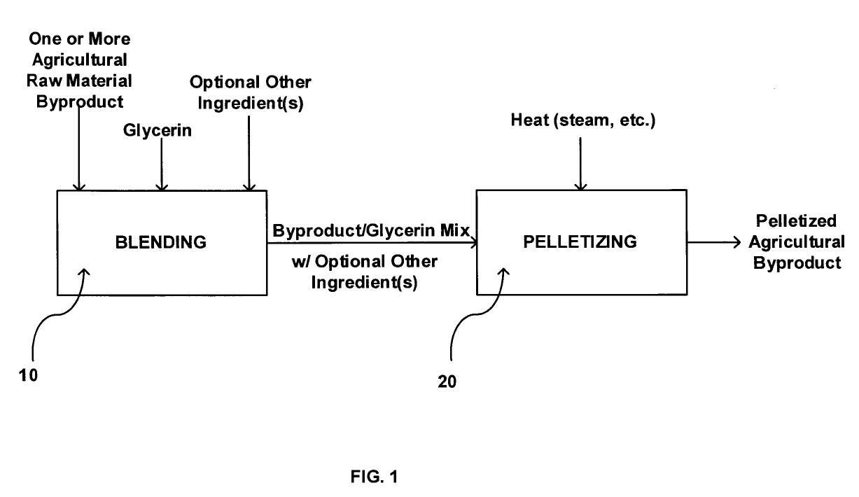

FIG. 1 is a block diagram illustrating the steps in the practice of the present invention for producing formulations consisting of agricultural raw material byproducts, glycerin and, if desired, other ingredients. Block 10 in FIG. 1 schematically illustrates the blending step, in which the agricultural raw material byproducts, the glycerin component and, if desired, other ingredients, such as one or more of the disclosed additive ingredients including, for example, nutritional additives, vitamins, minerals, antibiotics, hormones and sweeteners, are combined and mixed. Block 20 in FIG. 1 schematically illustrates the pelletizing step, in which the blended ingredients are compressed into pellet form. Heat, e.g. in the form of steam, may be added to assist in the pelletizing and to drive off excess moisture content from the pellets.

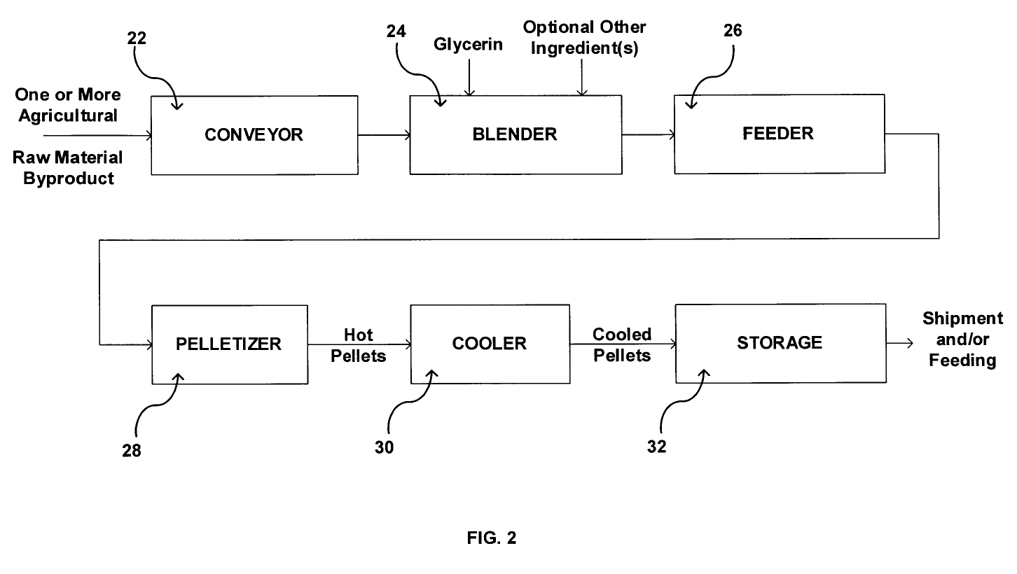

FIG. 2 is a schematic diagram of a plant constructed with the present invention for producing formulations comprising agricultural raw material byproducts, glycerin and, if desired, one or more of the other disclosed additive ingredients. As shown in FIG. 2, a conveyor 22 conducts the agricultural raw material byproducts to a blender 24. The blender 24 may be operated in either a continuous or batch blending mode. In one embodiment, a suitable blender is a ribbon blender. In one embodiment, a stream of glycerin is fed to the blender. In other embodiments, one or more of the disclosed additive ingredients such as, for example, nutritional additives, vitamins, minerals, antibiotics, hormones and sweeteners, may be added to the blender as desired.

A feeder 26 conducts the blended product to a pelletizer 28. This pelletizer is operated in a continuous mode. Typical suitable pelletizers include pelletizing extruders and pellet mills. In one embodiment, steam may be added to enhance the pelletizing process by increasing temperature in the pelletizer. In one embodiment, the pellets discharged from the pelletizer are conducted to a cooler 30 to cool the pelletized product to a temperature suitable for storage. The pelletized product may be stored in a suitable storage bin 32.

In another example of an extrusion pelletizing process, a glycerin-byproduct mixture is prepared from glycerin, a suitable agricultural raw material byproduct, including any optional ingredients as needed for a particular formulation. The glycerol-byproduct mixture is combined in a suitable mixer. In the mixer, water or steam, or both, can be added to the glycerin-byproduct mixture if needed. The moisture content of the glycerin-byproduct mixture may be, e.g., from about 5% to about 10% by weight. The temperature of the glycerin-byproduct mixture may be from about 20° C. to about 95° C. Although higher temperatures can be used if, for example, the mixture is protected from exposure to the atmosphere and the temperature is not more than about 130° C., the mixture should be cooled to a lower temperature before pellet formation to avoid expansion due to vaporization of water in the pellet. The glycerin-byproduct mixture in the mixer is then fed into an extruder.

The extruder may be any suitable extruder. In one embodiment, the extruder may be a single or twin screw extruder. In another embodiment, the extruder includes suitable heating and cooling sections. Suitable extruders are known in the pelletizing art.

In one embodiment, while being passed through the extruder, the glycerin-byproduct mixture may be passed through a cooking zone, in which the mixture is both subjected to mechanical shear and heated to a temperature up to about 130° C. During the cooking in the extruder, aided by the glycerin, the starch ingredients may react with the protein components in a “browning” reaction, e.g., a Maillard reaction. As is known, the browning reaction is important since it results in improved absorption of the protein/amino acid component by the animal to which the mixture is fed. In one embodiment, the browning reaction includes a Maillard Reaction, in which a carbonyl group of, e.g., a reducing sugar or aldose reacts upon heating with a terminal amine or free amine group of a protein to form products such as an N-glycosylamine. As is known in the art, such reactions may include a number of variations and possible rearrangements (such as the Amadori rearrangement to form ketosamines, which may in turn further react) of product or intermediate structures, but the Maillard reaction and browning reactions in general are based on the reaction between sugars and proteins or amino acids. Other browning reactions may also occur, such as caramelization, but the Maillard reaction is of primary interest in this regard.

In one embodiment, when the mixture is browned, e.g., by a Maillard reaction, absorption of protein/amino acids by dairy cattle is improved from about 35% of the protein to about 65% of the protein. Thus, in one embodiment, the browned mixture results in improved bypass in diary cows and other ruminants. Although not to be bound by theory, it is thought that the “browned” protein is immobilized or rendered less useable by rumen organisms and so more intact or animal-useable protein passes through the rumen.

In one embodiment, the process of blending and pelletizing includes exposing the byproduct and glycerin to an elevated temperature prior to pelletizing. In one embodiment, the process of blending and pelletizing includes exposing the byproduct and glycerin to an elevated temperature and then reducing the elevated temperature to a reduced temperature prior to pelletizing. In one embodiment, the elevated temperature is sufficient to result in a browning reaction. As disclosed above, in one embodiment, the elevated temperature may be about 130° C., while in another embodiment, the elevated temperature may be in the range from about 105° C. to about 140° C. In one embodiment, the reduced temperature is less than 100° C., and in one embodiment is substantially below 100° C., while in another embodiment, the reduced temperature is about 98° C. or less. The foregoing reduced temperatures should be attained prior to exposure to about atmospheric pressure, while the elevated temperatures may be generally at super-atmospheric pressures. As will be recognized by the person of skill in the art, inside an extrusion-type pelletizing apparatus, the pressure is likely to be elevated well above atmospheric pressure. As will also be recognized, when the pelletized mixture exits the extrusion-type pelletizing apparatus, it will be quickly exposed to a relatively lower pressure, i.e., to substantially atmospheric pressure. The temperature of the byproduct and glycerin mixture should already be at the lower values, or at least below about 100° C., in order to avoid sudden vaporization of water in the pellet.

In an embodiment in which the glycerin-byproduct mixture is heated to temperatures above 100° C., the extruder may suitably include a cooling or reduced temperature zone, in which the temperature of the mixture is reduced to less than 100° C., e.g., to 70° C. to 95° C., or to a lower temperature range, such as 40° C. to 80° C., prior to extrusion and pellet forming. If the temperature is allowed to remain greater than 100° C., any water present in the glycerin-byproduct mixture may be suddenly vaporized upon release of the mixture from the high pressure environment of the extruder into the relatively lower or reduced pressure external environment, resulting in loss of density of the pellets, puffing or cell formation in the pellets, and/or formation of a soft-textured product that does not have the benefits of the pellets of the present invention.

As the glycerin-byproduct mixture exits the extruder, it is forced through a pellet-forming die. Any suitable die may be used, as long as it provides pellets of the desired consistency and size. For example, the orifice of the die may be chosen to provide pellets having a pellet size, for example, from about ⅛″ (about 3.2 mm) to about ½″ (about 12.7 mm) and in one embodiment, a die opening of about 5/32″ (about 4 mm). Of course, larger pellets may also be formed, as needed by or preferred for feeding to particular animals.

In one embodiment, upon leaving a die as an elongated extrudate, the extruded glycerin-byproduct mixture is cut into pieces as known. This may be with suitable blades arranged such that the pieces have a length to provide a pellet having a length somewhat larger than its diameter, for example a length from about 5 mm to about 15 mm in an ovoid pellet, where the length exceeds the diameter at the “waist” of the pellet.

In one embodiment, the temperature range of the extrusion/pelletizing ranges from about 40° C. to about 98° C., and in another embodiment, from about 50° C. to about 95° C. In general, the extrusion/pelletizing temperature should be sufficiently less than the boiling point of water at the ambient pressure of the environment at the exit from the extrusion/pelletizing apparatus to avoid rapid vaporization of water included in the pellets. Thus, for example, where the environment at the exit from the extrusion/pelletizing apparatus is at or near normal atmospheric pressure, the temperature should be less than about 100° C.

In one embodiment, the product is pelletized, as opposed to expanded. That is, the product pellets are not expanded as is the case with some animal feeds known in the art. In one embodiment, the pellets thus formed do not have a cellular structure, i.e., the pellets do not have a large number of internal voids or spaces. In one embodiment, the pellets are substantially free of macroscopic voids, and in another embodiment are substantially free of microscopic voids. As used here, substantially free of such voids means that, to the extent any such voids are present, the strength and/or durability of the pellets are not reduced below a durability of 90% as determined by the method described herein for such pellets. “Substantially free” thus does not require that the pellets be completely free of all voids, which is unlikely given the wide variety of possible agricultural raw material byproducts used herein, but that the number and size of such voids should not cause any significant loss of the desirable strength and durability characteristics of the pellets.

In one embodiment, the process further includes reducing the particle size of the one or more agricultural raw material byproduct. Such reducing may include grinding, chopping, cutting, comminuting, blending or any other known particle-size reduction technique. In one embodiment, the particle size reducing is before the blending, and in another is subsequent to blending but before the pelletizing. In one embodiment, the particle size reduction takes place in the extruder apparatus, resulting from the particles being broken up, e.g., by action of the screw in the extruder.

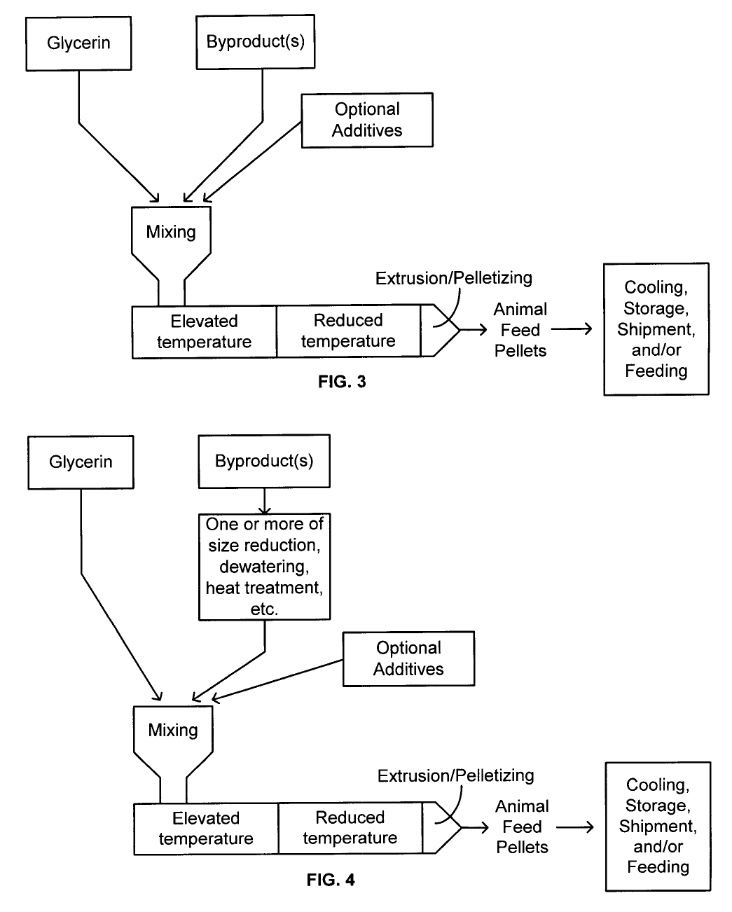

FIGS. 3 and 4 are schematic diagrams illustrating additional embodiments of processes for producing pelletized formulations comprising agricultural raw material byproducts, glycerin and, if desired, other ingredients.

FIG. 3 schematically illustrates an apparatus for carrying out the process of the present invention for producing animal feed in pelletized form from a mixture of glycerin, one or more agricultural raw material byproduct and, optionally, additional ingredients such as the nutritional additives, vitamins, etc. described above. As shown in FIG. 3, glycerin, one or more byproduct and, optionally, other additives, may be combined together in a mixing apparatus. The mixing apparatus mixes the combined ingredients and feeds them in the illustrated embodiment, into an extrusion apparatus. The extrusion apparatus further mixes the combined ingredients, transferring them into an extrusion/pelletizing section, in which the mixture is extruded or otherwise formed into pellet form. The resulting animal feed pellets are then transferred to cooling, storage, shipment and/or feeding steps. As illustrated in FIG. 3, the extrusion apparatus may include one or more zone of elevated temperature, and may further include one or more zone of reduced temperature. These temperature zones in one embodiment correspond to those described above, in which, in one embodiment, the mixture is subjected to conditions under which browning reaction can occur. The relative sizes of the various parts of FIG. 3 are not intended to be limiting or to any particular scale, but are merely illustrative.

FIG. 4 schematically illustrates an apparatus for carrying out the process of the present invention for producing animal feed in pelletized form from a mixture of glycerin, one or more agricultural raw material byproduct and, optionally, additional ingredients such as the nutritional additives, vitamins, etc. described above. As shown in FIG. 4, glycerin, one or more byproduct and, optionally, other additives, may be combined together in a mixing apparatus. In the embodiment illustrated in FIG. 4, the byproduct(s) or one or more of them, are subjected to additional optional treatment steps, such as, for example, size reduction (the aforementioned grinding, cutting, chopping, etc.), dewatering, heat treatment, etc. Although not shown, the optional additives may be combined with the byproducts prior to the optional steps illustrated in FIG. 4. Following the optional treatment step illustrated in FIG. 4, the mixing apparatus mixes the combined ingredients and feeds them in the illustrated embodiment, into an extrusion apparatus. The extrusion apparatus further mixes the combined ingredients, transferring them into an extrusion/pelletizing section, in which the mixture is extruded or otherwise formed into pellet form. The resulting animal feed pellets are then transferred to cooling, storage, shipment and/or feeding steps. As illustrated in FIG. 4, the extrusion apparatus may include one or more zone of elevated temperature, and may further include one or more zone of reduced temperature. These temperature zones in one embodiment correspond to those described above, in which, in one embodiment, the mixture is subjected to conditions under which browning reaction can occur. The relative sizes of the various parts of FIG. 4 are not intended to be limiting or to any particular scale, but are merely illustrative.

In one embodiment, the animal feed is a combination of one or both of soybean hulls and oat hulls and glycerin. In one such embodiment including both soybean hulls and oat hulls, the ratio of soybean hulls to oat hulls may range from about 10:1 to about 1:10. In one such embodiment, the animal feed is prepared to have an average dry weight ratio of the one or both of soybean hulls and oat hulls to the glycerin of about 10:1. Other ratios of the hulls to glycerin may be used, as disclosed herein for other combinations of agricultural raw material byproducts and glycerin. In one embodiment using one or both of soybean hulls and oat hulls and glycerin, the resulting animal feed has a bulk density in the range of about 35 lbs/ft³ to about 42 lbs/ft³ when pelletized. The bulk density may be outside this range. In one embodiment using one or both of soybean hulls and oat hulls and glycerin, when pelletized, pellets of the animal feed have a pellet durability in the range of about 97 to about 98.5 percent when pelletized. Thus, using either or both of soybean hulls and oat hulls, in accordance with the invention, quite good pellet durabilities may be obtained.

In one exemplary embodiment, the raw material byproduct is soybean hulls and after pelletizing the pellets have a pellet density of about 35.8 lbs/ft³ or greater and a pellet durability of about 98.5% or greater. In another exemplary embodiment, the raw material byproduct is oat hulls and after pelletizing the pellets have a pellet density of about 41 lbs/ft³ or greater and a pellet durability of about 97% or greater.

### EXAMPLES

### Example 1

A batch of 10 parts by weight of dried distiller's grain with solubles (DDGS), a well known agricultural raw material byproduct, containing 10.7% of moisture by weight is blended in a horizontal ribbon blender with 1 part by weight of glycerin containing 14.5% of moisture by weight. The ratio on a dry basis is 8.9 parts of DDGS by weight to 0.86 parts of moisture-free glycerin by weight. The temperature of the blended product may range from about 60° F. to about 90° F. (about 15° C. to about 32° C.). The blended product is subsequently fed to a pellet mill (in one embodiment a California Pellet Mill, Master model with 40 HP motor). This pellet mill is operated at a compression ratio of about 8:1. The die opening is about 5/32″ (about 4 mm). The exit temperature of the pellets is about 148° F. (about 64° C.). The moisture content of the pellets is 9.7% by weight after drying and cooling. The durability of the pellets is 98.7%. After cooling the bulk density of the pellets is about 35 lb/ft³ (about 560 kg/m³). The energy density of the finished pellet product is about 1,320 Kcal/lb on a dry weight basis.

### Example 2

A batch of 10 parts by weight of a mixture of oilseed byproducts, including soybean hulls, cottonseed hulls, soybean meal, cottonseed meal and sunflower seed meal, containing about 10% of moisture by weight is blended in a horizontal ribbon blender with 1 part by weight of glycerin containing about 14% of moisture by weight. The ratio on a dry basis is 9 parts of dry oilseed byproducts by weight to 0.86 parts of moisture-free glycerin by weight. The temperature of the blended product generally ranges from about 60° F. to about 90° F. (about 15° C. to about 32° C.). The blended product is subsequently fed to a pellet mill (same as used in Example 1 above). The die opening is 5/32″ and the mill is operated at a compression ratio of 11.5:1. The exit temperature of the pellets is 133° F. (about 56° C.). The moisture content of the pellets is about 9.5% by weight after drying and cooling. The durability of the pellets is 95%. After cooling the bulk density of the pellets is 35 lb/ft³ (about 560 kg/m³). The energy density of the finished pellet product is about 1,240 Kcal/lb. on a dry weight basis.

### Example 3

A batch of 10 parts by weight of agricultural raw material byproducts, including corn gluten meal, whole cottonseed, cottonseed meal, soybean meal and hulls, containing about 15% moisture by weight is blended in a horizontal ribbon blender with 1.3 parts by weight of glycerin containing about 10% moisture by weight. The ratio on a dry basis is 8.5 parts by weight of the byproducts and 1 part by weight of moisture-free glycerin. The temperature of the blended product ranges from about 60° F. to about 90° F. (about 15° C. to about 32° C.). The blended product is subsequently fed to a pellet mill (same as in Examples 1 and 2 above). The die opening is 5/32″ and the mill is operated at a compression ratio of 11.5:1. The exit temperature of the pellets is 120° F. (about 49° C.). Moisture content of the pellets is about 12% by weight after drying and cooling. The durability of the pellets is 98%. After cooling the bulk density of the pellets is 33 lb/ft³ (about 529 kg/m³). The energy density of the finished pellet product is 1,300 Kcal/lb. on a dry weight basis.

### Example 4

A batch of 10 parts by weight of soybean hulls containing about 10% moisture by weight is blended in a horizontal ribbon blender with 1 part by weight of glycerin containing about 14% of moisture by weight. The ratio on a dry basis is 9 parts of soybean hulls by weight to 0.86 parts of moisture-free glycerin by weight. The blended product is subsequently fed to a pellet mill (same as in Example 1 above). The die opening is 5/32″ and the mill is operated at a compression ratio of 8.5:1. The exit temperature of the pellets is 158° F. (70° C.). The durability of the pellets is 98.5%. Pellet density is 35.8 lbs/ft³ (about 570 kg/m³). The energy density of the finished pellet product is about 1,240 Kcal/lb on a dry weight basis.

### Example 5

A batch of 10 parts by weight of oat hulls containing about 10% moisture by weight is blended in a horizontal ribbon blender with 1 part by weight of glycerin containing about 14% of moisture by weight. The ratio on a dry basis is 9 parts of oat hulls by weight to 0.86 parts of moisture-free glycerin by weight. The blended product is subsequently fed to a pellet mill (same as used in Example 1 above). The die opening is ¼″ and the mill is operated at a compression ratio of 9:1. The exit temperature of the pellets is 175° F. (79° C.). The durability of the pellets is 97%. Pellet density is 41 lbs/ft³ (about 660 kg/m³). The energy density of the finished pellet product is about 1,240 Kcal/lb on a dry weight basis.

While the invention has been explained in relation to certain of its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. An animal feed in pellet form comprising
one or more agricultural raw material byproduct; and
a glycerin binder.

2. The animal feed of claim 1, wherein the glycerin binder is present at a concentration sufficient to bind the one or more byproduct into a durable pellet.

3. The animal feed of claim 1 wherein the animal feed comprises an average weight ratio of the one or more byproduct combined to glycerin in the range from about 50:1 to about 3:1.

4. The animal feed of claim 3 wherein the animal feed comprises an average weight ratio of the one or more byproduct combined to glycerin in the range from about 10:1 to about 4:1.

5. The animal feed of claim 1 wherein the animal feed bulk density is in the range of about 25 lb/ft³ to about 45 lb/ft³ when pelletized

6. The animal feed of claim 1 wherein the energy content of the animal feed is in the range from about 1,260 Kcal/lb to about 1,500 Kcal/lb on a dry weight basis.

7. The animal feed of claim 1 wherein pellet durability is in the range from about 90% to about 99%.

8. The animal feed of claim 1 further comprising one or more of nutritional additives, vitamins, minerals, antibiotics, hormones and sweeteners.

9. The animal feed of claim 8 wherein the nutritional additives comprise one or more of phospholipids, water-soluble phosphorus compounds and water-soluble sulfur compounds.

10. The animal feed of claim 1 wherein the one or more byproduct includes a combination of the byproducts and/or nutritional additives selected to provide a nutritionally effective amount of protein, fat, carbohydrate and/or nutritional additive.

11. The animal feed of claim 1 wherein glycerin binder is present at a concentration effective to improve shelf life of the one or more byproduct.

12. The animal feed of claim 1 wherein the animal feed is a combination of one or both of soybean hulls and oat hulls and glycerin at an average dry weight ratio of the one or both of soybean hulls and oat hulls to the glycerin of about 10:1.

13. The animal feed of claim 12 wherein the animal feed bulk density is in the range of about 35 lbs/ft³ to about 42 lbs/ft³ when pelletized.

14. The animal feed of claim 12 wherein when pelletized, pellets of the animal feed have a pellet durability in the range of about 97 to about 98.5 percent when pelletized.

15. A process for preparing an animal feed product, comprising
providing one or more agricultural raw material byproduct;
blending the one or more byproduct with a quantity of glycerin; and
pelletizing the blended byproduct and glycerin into pellets.

16. The process of claim 15 wherein the glycerin is present at a concentration effective to bind the one or more byproduct and glycerin into a durable pellet.

17. The process of claim 15 wherein the animal feed comprises an average weight ratio of the one or more byproduct combined to glycerin in the range from about 50:1 to about 3:1.

18. The process of claim 15 wherein the animal feed comprises an average weight ratio of the one or more byproduct combined to glycerin in the range from about 10:1 to about 4:1.

19. The process of claim 15 wherein the animal feed bulk density is in the range of about 25 lb/ft³ to about 45 lb/ft³ when pelletized.

20. The process of claim 15 wherein the energy content of the animal feed is in the range from about 1,260 Kcal/lb to about 1,500 Kcal/lb. on a dry weight basis.

21. The process of claim 15 wherein pellet durability is in the range from about 90% to about 99%.

22. The process of claim 15 further comprising adding one or more of nutritional additives, vitamins, minerals, antibiotics, hormones and sweeteners to the blend of the one or more byproduct and glycerin.

23. The process of claim 22 wherein the nutritional additives comprise one or more of phospholipids, water-soluble phosphorus compounds and water-soluble sulfur compounds.

24. The process of claim 22 wherein the nutritional additives are introduced in the form of wash water from a de-gumming process for crude vegetable oils or rendered fats or a concentrate thereof.

25. The process of claim 15 further comprising selecting a combination of the one or more byproduct and/or nutritional additive to provide a nutritionally effective amount of protein, fat, carbohydrate and/or nutritional additive.

26. The process of claim 15 further comprising reducing particle size of the one or more byproduct.

27. The process of claim 15 further comprising exposing the blended one or more byproduct and glycerin to an elevated temperature and reducing the temperature to a reduced temperature prior to the pelletizing.

28. The process of claim 27 wherein the elevated temperature is sufficient to result in a browning reaction.

29. The process of claim 27 wherein the reduced temperature is less than 100° C.

30. The process of claim 15 wherein the glycerin is effective to improve shelf life of the one or more byproduct.

31. The process of claim 15 wherein the raw material byproduct is one or both of soybean hulls and oat hulls at an average dry weight ratio of the one or both of soybean hulls and oat hulls to the glycerin of about 10:1.

32. The process of claim 31 wherein the raw material byproduct is soybean hulls and after pelletizing the pellets have a pellet density of about 35.8 lbs/ft³ or greater and a pellet durability of about 98.5% or greater.

33. The process of claim 31 wherein the raw material byproduct is oat hulls and after pelletizing the pellets have a pellet density of about 41 lbs/ft³ or greater and a pellet durability of about 97% or greater.
